(19) United States
(12) Patent Application Publication
(10) Pub. No.: US 2011/0191503 A1
(43) Pub. Date: Aug. 4, 2011

(54) Motherboard Compatible with Multiple Versions of Universal Serial Bus (USB) and Related Method

(76) Inventor: Musa Ibrahim Kakish, Anaheim, CA (US)

(21) Appl. No.: 12/699,884

(22) Filed: Feb. 4, 2010

(51) Int. Cl. G06F 13/20; G06F 13/10

(52) U.S. Cl. 710/15; 710/305

(57) ABSTRACT

A mother board compatible with multiple versions of universal serial bus (USB) is disclosed. The motherboard comprises a connector, a host controller interface (HCI) means, a serial bus slot, and a detection unit. The connector is used for exchanging signals of a first USB version and signals of a second USB version with an external USB device. The host HCI means is coupled to the connector through a first data line, for proving the signals of the first USB version. The serial bus slot is coupled to the connector through a second data line, for conveying the signals of the second USB version. The detection unit is coupled to the serial bus slot for detecting an insertion state of the serial bus slot and the functionality of the second USB version, and generating a detection result.

### BACKGROUND OF THE INVENTION

1. Field of the Invention

The present invention relates to a motherboard and related method, and more particularly, to a motherboard compatible with multiple versions of universal serial bus (USB) and a method of minimizing configuration changes on the motherboard.

2. Description of the Prior Art

Universal Serial Bus (USB) is a public interface standard for accessing peripheral devices and personal computers. Recently, the application of USB has been extended to a large number of consumer electronics and mobile devices, Interfaces complying with the specification of the USB 2.0 have now been enjoying wide application, since the USB 2.0 interface has a highest speed of 480 Mb/S and also the capability of power supply, which leads to the popularity of the USB 2.0 interface in the current field of PC interface. As storage capacity and network speed enters the epoch of Gigabyte, however, the data connection between a computer and peripheral devices requires a higher transmission rate, and USB 2.0 is having difficulty in meeting the continuous growing requirement of access rate. Therefore, there is a pressing need for a new interface (e.g. extensible host controller interface (xHCI)) specification with respect to data connection between the computer and peripheral devices.

The aforementioned related USB integrated circuit is described in US Patent 2005/0249143A1. This document describes an integrated circuit comprising a transceiver circuit and a USB host controller with a standard interface for use inside an apparatus, but with a connection for an external USB device controller. That is, for the host function the integrated circuit acts as a complete USB interface, whereas for the device function it provides for mere transceiver functionality between its external terminals. Thus, functional circuits with built-in device controller and a standard intra-apparatus bus can be interfaced to a USB bus via the integrated circuit both as host and as device.

In order to meet the demands for higher data transmission, a USB 3.0 already made her debut in November, 2008. The USB 3.0 promises 4.8 Gbps “SuperSpeed” data transfers and its raw throughput can reaches 4 Gbps. When operating in “SuperSpeed”, the USB 3.0 adopts “full duplex” signaling over two differential pairs separating from non-superspeed differential pairs. As a result, USB 3.0 cables contain 2 wires for power and ground, 2 wires for non-SuperSpeed data, and 4 wires for SuperSpeed data, and a shield. In contrast, the USB 2.0 cables contain a transmission pair for data. Apart from that, SuperSpeed establishes a communications pipe between the host and each device, in a host-directed protocol. But USB 2.0 broadcasts packet traffic to all devices. Certainly, the USB 3.0 has many features different than the USB 2.0 and those differences are well known by those skilled in the art, and thus not elaborated on herein.

Therefore, communicating with the USB 3.0 peripheral devices may be carried out by several ways. For example, some motherboard models have introduced on-board USB 3.0 to support USB 3.0.functionality. And it is easy for the users who feel like experiencing the “SuperSpeed” data transfer and USB 3.0 features. But, for the manufacturers who wouldn't like to remodel the motherboards on their current products or for the consumers who already have their old model mother board built in their laptops, but intend to connect the USB 3.0 peripheral devices, the USB 3.0 motherboard does not seem friendly to them. Thus, there is an alternative way provided for those demands for USB 3.0 functionality.

As known, a mini peripheral component interconnect express (MiniPCIe) interface has been applied widely to laptops and capable of supporting all kinds of MiniPCIe card, such as video card, graphic card, audio card, adaptor card and the like. Also, the MiniPCIe interface supports “plug and play”, which facilitates the discovery of a hardware component in the computer system, without the need for physical device configuration, or user intervention in resolving resource conflicts. Since the MiniPCie interface posses such fascinating attributes, the Add-On card vendors would come up with a solution to implement the USB 3.0 functionality. By use of the xHCI controller embedded in an add-on card (e.g. PCIe card), it is feasible for the computer system without on-board USB3.0 to perform the USB 3.0 functionality. Therefore, by inserting the PCIe card with xHCI controller, the computer system is able to communicate with the USB 3.0 peripheral devices.

Even though the USB 3.0 add-on card has been developed lately, however, there still exists a challenge for the current computer system. For example, most of the current motherboards come equipped with USB 2.0 interface. The backward compatibility must be provided on the motherboard when USB 3.0 add-on card is applied. Thus, new routing rules or modifications may be made for the motherboard in order to manage the backward compatibility. But those changes may result in design complexity and the cost of manufacturing. Undoubtedly, how to manage the backward compatibility with minimum modifications on the motherboard is a big challenge for the manufacturer so far.

### SUMMARY OF THE INVENTION

It is therefore an objective of the present invention to provide a motherboard compatible with multiple versions of universal serial bus (USB).

The present invention discloses a motherboard compatible with multiple versions of universal serial bus (USB). The motherboard comprises a connector, a host controller interface (HCI) means, a serial bus slot, and a detection unit. The connector is used for exchanging signals of a first USB version and signals of a second USB version with an external USB device. The host HCI means is coupled to the connector through a first data line, for proving the signals of the first USB version. The serial bus slot is coupled to the connector through a second data line, for conveying the signals of the second USB version. The detection unit is coupled to the serial bus slot for detecting an insertion state of the serial bus slot and the functionality of the second USB version, and generating a detection result.

The present invention further comprises a method of minimizing configuration changes on a motherboard compatible with multiple versions of universal serial bus (USB), wherein the motherboard comprises a connector, a host controller interface (HCI) means, a serial bus slot, and a detection unit. The method comprising the steps of routing a first data line for coupling the HCI means to the connector; routing a second data line for coupling the serial bus slot to the connector; and detecting an insertion state of the serial bus slot and the functionality of the second USB version, and generating a detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a motherboard according to an example of the present invention.

FIG. 2A is a schematic diagram of a motherboard according to another example of the present invention.

FIG. 2B illustrates the switch in FIG. 2A.

FIG. 3 is a flowchart of a process according to an example of the present invention.

### DETAILED DESCRIPTION

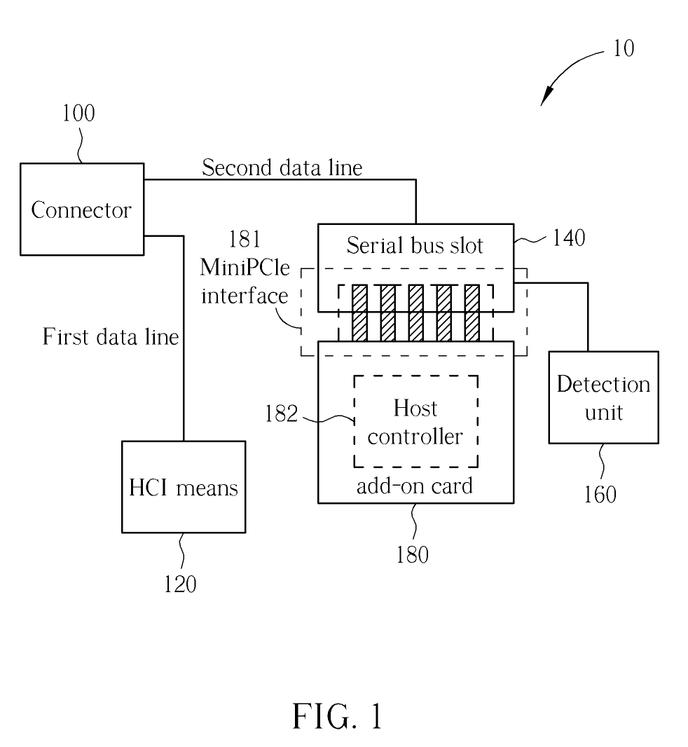

Please refer to FIG. 1, which is a schematic diagram of a motherboard 10 according to an example of the present invention. The motherboard 10 is compatible with multiple versions of universal serial bus (USB), such as USB 1.0, USB 2.0 and USB 3.0. The motherboard 10 may be applied to a computer system, such as a personal computer, a laptop, a server and the like. In other word, the motherboard 10 may support various USB functionalities on the computer system. The motherboard 10 comprises a connector 100, a host controller interface (HCI) means 120, a serial bus slot 140, a detection unit 160, and an add-on card 180. The connector 100 is used for exchanging signals of a first version USB and a second version USB with an external USB device. In some examples, the motherboard 10 is compatible with the USB 2.0 and the USB 3.0. This allows the external USB device (regardless of the USB 2.0 external devices or the USB 3.0 external devices) to plug in the connector 100, thereby performing signal exchanging with the motherboard 10. As known by those in the art, the connector 100 may adopt two typical sockets type A and type B but does not rule out any type socket as long as it fits the external USB device in different USB versions. In addition, the connector 100 comprises four pins (Vbus, D+, D−, and GND). In some examples, the connector 100 may be powered by the motherboard 10 through the Vbus pin.

The HCI means 120 is used for proving the signals of the first USB version. The various USB specifications may be introduced to the HCI means 120, allowing communications with an operation system of the computer system under different USB standards. Basically, a host controller is used for hardware implementation of the HCI means 120. The different host controller may follow different USB standards and provide different USB functionalities. For example, an open host controller interface (OHCI) controller and universal host controller interface (UHCI) controller may be applied to the HCI means 120 for implementation of the USB 1.1 functionality. For higher data transfer, an enhanced host controller interface (EHCI) may be employed to provide the USB 2.0 functionality. Certainly, the HCI means 120 may adopt any later version of USB specification, and not limited herein. Thus, the first USB version may be determined, based on the type of the host controller applied to the HCI means 120. The HCI means 120 is coupled to the connector 100 through a first data line. The first data line may be a USB line, closely related to the host controller of the first USB version. For example, when the HCI means 120 is implemented by the EHCI controller, the first data line may be a USB 2.0 line, transferring data between the connector 100 and the EHCI controller.

The serial bus slot 140 is used for conveying the signals of the second USB version. In some examples, the serial bus slot 140 may be referred as to a Mini peripheral component interconnect express (MiniPCIe) slot, supporting a MiniPCIe interface, which is a computer expansion card standard widely used in laptops. The serial bus slot 140 is coupled to the connector 100 through a second data line. The second data line is associated with the second USB version. The detection unit 160 is coupled to the serial bus slot 140 for detecting an insertion state of the serial bus slot and the functionality of the second version USB, and generating a detection result R_{detect}. In some example, the slot serial bus slot may be inserted by a video add-on card, an audio add-on card, or a wireless add-on card. In this situation, through the detection result R_{detect}, the motherboard 10 may be informed of absence of the second USB functionality even if the serial bus slot 140 is inserted. When the serial bus slot 140 is inserted with the USB version x add-on card, the detection result R_{detect} is generated indicating provision of the USB version x functionality. The detection unit 160 may be implemented by a hardware, software or firmware. For example, the detection unit 160 may be implemented by a sensor, a pin, or program codes and the detection result R_{detect} may be in any form, such as a pulse, a voltage drop, or current change or be displayed by a light emitting diode (LED) light, indicating whether the serial bus slot is inserted or not.

In some examples, an add-on card 180 may be inserted in the serial bus slot 140 for providing functionality of the second USB version. The add-on card 180 comprises MiniPCIe interface 181, and a host controller 182. In some examples, the add-on card 180 may be a MiniPCIe card and support the PCIe connectivity and the USB 2.0 connectivity both, according to a MiniPCIe interface specification. The host controller 182 is used for providing the functionality of the second version USB. In some examples, the host controller 182 may be an extensible host controller interface (xHCI) controller and meet USB 3.0 interface specification. In this situation, the add-on card 180 may provide USB 3.0 functionality and the second data line may be referred as to a USB 3.0 line. Basically, the host controller 182 may provide a later version USB than the HCI means 120, not limited to the xHCI controller. The MiniPCIe interface 181 comprises a reserved pin P. The reserved pin P is coupled to the connector 100 through the second data line when the add-on card 180 is inserted into the serial bus slot 140. In some examples, the MiniPCIe interface 181 may be a 52 pin card edge connector, and the card pins are fingers at the edge of the add-on card 180.

Thus, when the add-on card 180 is inserted into the serial bus slot 140, the motherboard 10 may have the first version USB and the second version USB by means of routing the first data line from the HCI means 120 to the connector 100 and routing the second data line from the serial bus slot 140 to the connector 100, thereby exchanging signals of the first version USB and the second version USB with the external USB device. When the add-on card 180 is not inserted into the serial bus slot 140, the motherboard 10 may still work as the first version USB. Thus, the embodiment of the present invention can minimize changes to the motherboard 10 and reduce the cost and complexity of the modification, and further facilitate implementation of multiple versions USB on the motherboard 10.

Taking an example, the connector 100 is a USB 3.0 connector, which is compatible with the external USB 3.0 device and the external USB 2.0 device, both. The HCI means 120 is implemented by an EHCI controller and performs USB 2.0 functionality. The serial bus slot 140 is a MiniPCIe slot. The detection unit 160 is a pin on the MiniPCIe slot. The detection result R_{detect} is displayed by a LED light. The add-in card 180 is a MiniPCIe card and comprises the MiniPCIe interface 181 and the host controller 182. The host controller 182 is xHCI controller, which performs USB 3.0 functionality. The first data line is a USB 2.0 line, meeting USB 2.0 data transfer standard. The EHCI controller is coupled to the USB 3.0 connector through the USB 2.0 line. The second data line is a USB 3.0 line, meeting USB 3.0 data transfer standard. The xHCI controller is coupled to the USB 3.0 connector through the reserved pin P on the MiciPCIe interface and the USB 3.0 line. When the MiniPCIe card is inserted into the MiniPCIe slot on the motherboard 10, the LED light turns on, indicating that motherboard 10 can have USB 2.0 features and USB 3.0 features. When a user plugs the external USB 3.0 device in the USB 3.0 connector, the MiniPCIe card accommodates with USB 3.0 features and performs “superspeed” data transfer via USB 3.0 line. When the user plugs the external USB 2.0 device in the USB 3.0 connector, the EHCI controller accommodate with USB 2.0 features and performs USB 2.0 data transfer via USB 2.0 line.

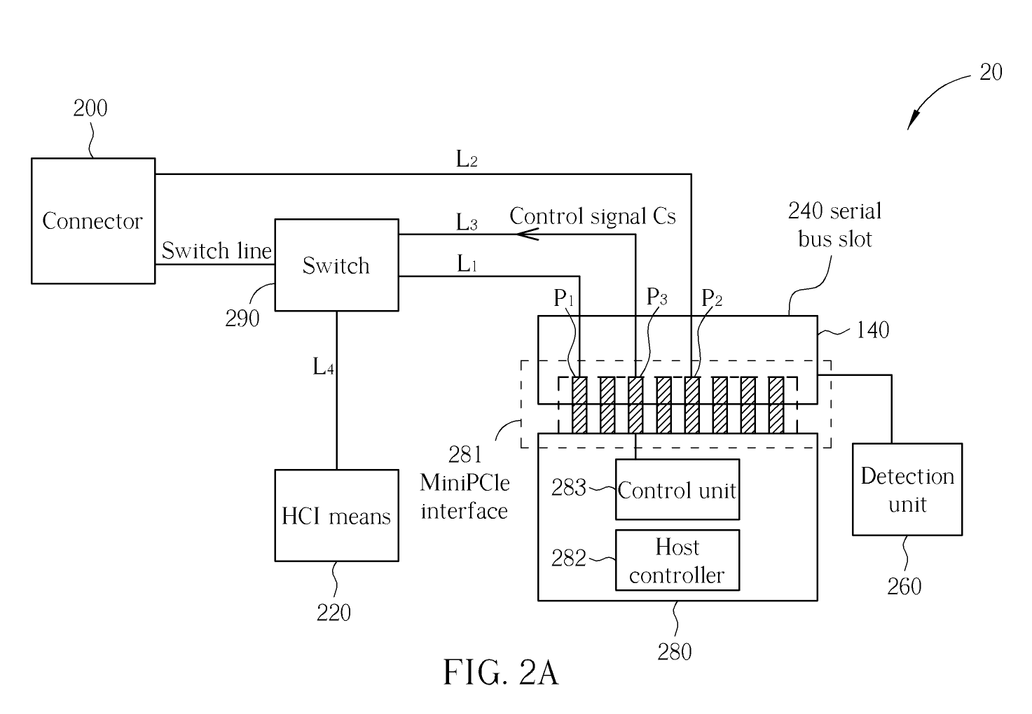

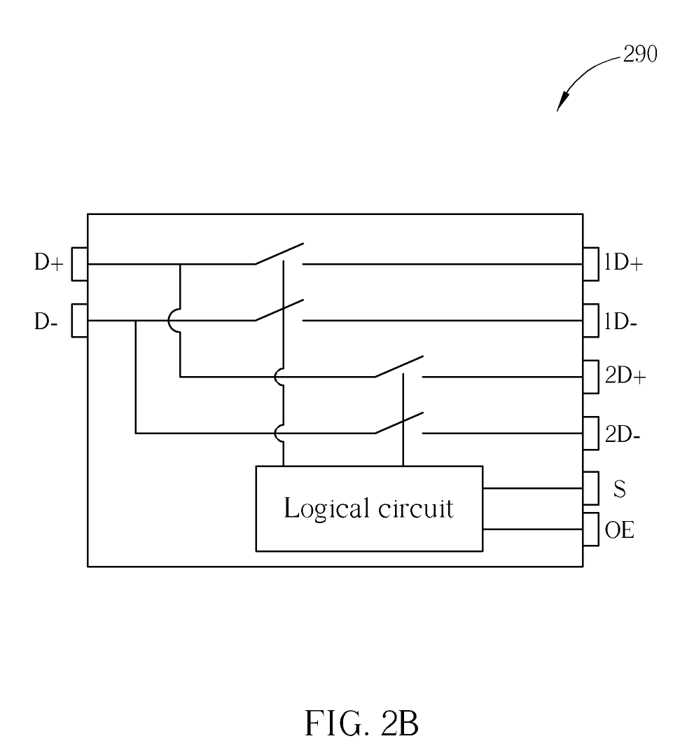

Please refer to FIG. 2A, which is a schematic diagram of a motherboard 20 according to another example of the present invention. Basically, the motherboard 20 has a similar structure as the motherboard 10. The only differences are that multiple data lines are routed and a switch is added on the motherboard 20. The motherboard 20 comprises a connector 200, a host controller interface (HCI) means 220, a serial bus slot 240, a detection unit 260, an add-on card 280, and a switch 290. The features of the connector 200, the HCI means 220, the serial bus slot 240, the detection unit 260, the add-on card 280 are similar to the features of the connector 100, the HCI means 120, the serial bus slot 140, the detection unit 160, the add-on card 180, respectively. The detailed description can be found above and thus not elaborated on herein. Only the differences will be described below. The add-on card 280 comprises a MiniPCIe interface 281, and a host controller 282 and a control unit 283. The control unit 283 is used for generating and sending a control signal Cs to the switch 290 when a detection result R_{detect2} (generated by the detection unit 260) indicates that the add-on card 280 is inserted into the serial bus slot 240 as well as when the functionality of the second USB version is provided. In some examples, the add-on card 280 may be a video card, an audio card, a wireless card, or any other cards not capable of supporting the second version USB. In this situation, the control signal Cs will not be generated and sent to the switch 290 even if the add-on card 280 is inserted into the serial bus slot 240, unless the add-on card 280 provides the functionality of the second version USB. In some examples, the control unit 283 may be implemented by the host controller 282, and the control signal Cs may have a length of one bit. The MiniPCIe interface 281 comprises reserved pins P1 and P2 and P3. The reserved pin P1 is coupled to the switch 290 through a data line L1. The reserved pin P2 is coupled to the connector 200 through a data line L2. The reserved pin P3 is coupled to the switch 290 through a data line L3. In some examples, the data line L1 may be a USB 2.0 line; the data line L2 may be a USB 3.0 line; the data line L3 may be a 2.0 Mux control line.

The switch 290 is used for selecting signals from the HCI means 220 or the add-on card 280 according to the control signal Cs. The switch 290 is coupled to the connector 200 through a switch line, to the HCI means 220 through a data line L4, and to the serial bus slot 240 through the data lines L1 and L3. In some examples, the switch 290 may be implemented by a multiplexer; the data line L4 may be the USB 2.0 line; the switch line may be a switched 2.0 line. Please refer to FIG. 2B, which illustrates the switch 290 according to an example of the present invention. The switch 290 is the multiplexer designed for the switching of high speed USB 2.0 signals in handset and consumer applications. As shown in FIG. 2B, the switch 290 multiplexes differential outputs from a USB host device (1D+, 1D−, 2D+, 2D−) to one of two corresponding outputs (D+,D−). A Pin S is an select input and a pin OE is used for enabling the switch. The logical circuit provides functions based on a truth table of the inputs of the Pin and the Pin OE. Please note that the switch 290 is not necessary for the present invention. It is because some operating system manufacturers do not develop a USB 3.0 driver in their operation system products. Therefore, the signals of the first version USB and the second version USB are controlled by the different controller.

Thus, the control unit 283 may send the control signal Cs to the switch 290 (e.g. Pin OE of the multiplexer) through the data line L3 when the add-on card 280 which provides the functionality of the second version USB is inserted into the serial bus slot 240. According to the control signal Cs, the switch 290 is enabled and selects signals either from the HCI means 220 or from the add-on card 280. As described above, the motherboard 20 may have the first version USB and the second version USB, thereby exchanging signals of the first version USB and the second version USB with the external USB device through the connector 200. When the add-on card 280 is not inserted into the serial bus slot 240 or the add-on card 280 does not provide the functionality of the second version USB, the motherboard 20 may still work as the first version USB. Therefore, if the user intends to use the functionality of the second version USB, the user just needs to insert the add-on card 280 into the computer, and then the whole system is automatically ready for connection of the second version USB. Such that, no complicated modification will be made on the motherboard. And this provides more convenient and easier way for the user to have multiple versions of USB on their personal computer.

Taking FIG. 2A as another example, the connector 200 is a USB 3.0 connector, which is compatible with the external USB 3.0 device and the external USB 2.0 device, both. The HCI means 220 is implemented by an EHCI controller and performs USB 2.0 functionality. The serial bus slot 240 is a MiniPCIe slot. The detection unit 260 is a pin on the MiniPCIe slot. The detection result R_{detect2} is displayed by a LED light. The add-in card 280 is a USB 3.0 MiniPCIe card and comprising the MiniPCIe interface and an xHCI controller. The switch 290 is a multiplexer, and coupled to the USB 3.0 connector through a switched 2.0 line, to the EHCI controller through the USB 2.0 line, and to the xHCI controller through the USB 3.0 line. In this example, the control unit 283 is implemented by the xHCI controller, so the 2.0 Mux control line is routed from the xHCI controller to the multiplexer for transmission of a one-bit control signal. When the USB 3.0 MiniPCIe card is inserted into the MiniPCIe slot on the motherboard 10, the LED light turns on and the xHCI controller sends the one bit control signal to the multiplexer. The multiplexer is enabled by the one bit control signal. The multiplexer may select signals from the EHCI controller when the external USB 2.0 device is plugged into the USB 3.0 connector. The multiplexer may select signals from the USB 3.0 MiniPCIe card when the external USB 3.0 device is plugged into the USB 3.0 connector. When no USB 3.0 MiniPCIe card is inserted into the MiniPCIe slot, the multiplexer is not enabled. At this moment, only USB 2.0 functionality is available.

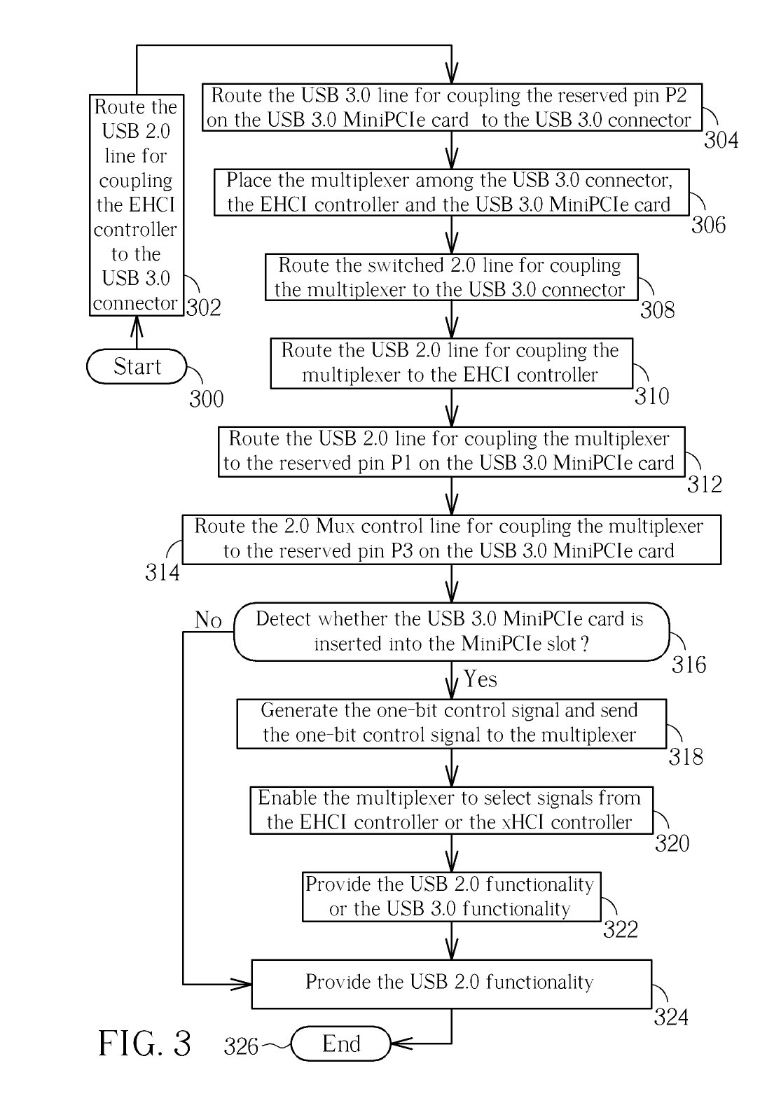

Please refer to FIG. 3, which is a flowchart of the process 30 according to the example of the present invention. The process 30 is used for minimizing configuration changes on the motherboard 20 compatible with multiple versions of USB. The process 30 includes the following steps:

Step 300: Start.

Step 302: Route the USB 2.0 line for coupling the EHCI controller to the USB 3.0 connector.

Step 304: Route the USB 3.0 line for coupling the reserved pin P2 on the USB 3.0 MiniPCIe card to the USB 3.0 connector.

Step 306: Place the multiplexer among the USB 3.0 connector, the EHCI controller and the USB 3.0 MiniPCIe card.

Step 308: Route the switched 2.0 line for coupling the multiplexer to the USB 3.0 connector.

Step 310: Route the USB 2.0 line for coupling the multiplexer to the EHCI controller.

Step 312: Route the USB 2.0 line for coupling the multiplexer to the reserved pin P1 on the USB 3.0 MiniPCIe card.

Step 314: Route the 2.0 Mux control line for coupling the multiplexer to the reserved pin P3 on the USB 3.0 MiniPCIe card.

Step 316: Detect whether the USB 3.0 MiniPCIe card is inserted into the MiniPCIe slot? If so, go to Step 318; Otherwise, go to Step 324.

Step 318: Generate the one-bit control signal and send the one-bit control signal to the multiplexer.

Step 320: Enable the multiplexer to select signals from the EHCI controller or the xHCI controller.

Step 322: Provide the USB 2.0 functionality or the USB 3.0 functionality.

Step 324: Provide the USB 2.0 functionality.

Step 326: End.

The process 30 is based on the operations of the motherboard 20. The detailed description can be found above, and thus omitted herein.

To sum up, the abovementioned examples of re-configuring the motherboard minimize changes to the motherboard and reduce the cost and complexity of the modification, and further facilitate implementation of multiple versions of USB on the motherboard.

Those skilled in the art will readily observe that numerous modifications and alterations of the device and method may be made while retaining the teachings of the invention.

What is claimed is:

1. A motherboard compatible with multiple versions of universal serial bus (USB), the motherboard comprising:
a connector for exchanging signals of a first USB version and signals of a second USB version with an external USB device;
a host controller interface (HCI) means coupled to the connector through a first data line, for proving the signals of the first USB version;
a serial bus slot coupled to the connector through a second data line, for conveying the signals of the second USB version; and
a detection unit coupled to the serial bus slot for detecting an insertion state of the serial bus slot and the functionality of the second USB version, and generating a detection result.

2. The motherboard of claim 1 further comprising an add-on card having a Mini peripheral component interconnect express (MiniPCIe) interface, inserted in the serial bus slot for providing functionality of the second USB version.

3. The motherboard of claim 2, wherein the add-on card further comprises a control unit for generating a control signal when the detection result indicates that the add-on card is inserted into the serial bus slot and the functionality of the second USB version is provided.

4. The motherboard of claim 3 further comprising a switch coupled to the HCI means, the serial bus slot and the connector, for selecting signals from the HCI means or the add-on card according to the control signal.

5. The motherboard of claim 2, wherein the MiniPCIe interface comprises:
a first reserved pin coupled to the switch through the first data line;
a second reserved pin coupled to the connector through the second data line; and
a third reserved pin coupled to the switch through a third data line.

6. The motherboard of claim 4, wherein the switch is a multiplexer.

7. A method of minimizing configuration changes on a motherboard compatible with multiple versions of universal serial bus (USB), the motherboard comprising a connector, a host controller interface (HCI) means, a serial bus slot, and a detection unit, the method comprising the steps of:
routing a first data line for coupling the HCI means to the connector;
routing a second data line for coupling the serial bus slot to the connector; and
detecting an insertion state of the serial bus slot and the functionality of the second USB, and generating a detection result.

8. The method of claim 7 further comprising the steps of:
placing a switch among the connector, the HCI means and the serial bus slot;
routing a third data line for coupling the serial bus slot to the switch;
routing a switch line for coupling the switch to the connector; and
routing the first data line for coupling the switch to the HCI means.

9. The method of claim 7 further comprising the step of inserting an add-on card having a Mini peripheral component interconnect express (MiniPCIe) interface into the serial bus slot for providing functionality of the second USB version.

10. The method of claim 9, wherein the MiniPCIe interface comprises:
a first reserved pins coupled to the connector and the HCI means through the first data line;
a second reserved pin coupled to the connector through the second data line; and
a third reserved pin coupled to the switch through the third data line.

11. The method of claim 9 further comprising generating a control signal when the detection result indicates that the add-on card is inserted into the serial bus slot and the functionality of the second USB version is provided.

12. The method of claim 11 further comprising enabling a switch to select signals from the HCI means or the add-on card, according to the control signal.

13. The method of claim 8, wherein the switch is a multiplexer.
